(19) United States
(12) Patent Application Publication
(10) Pub. No.: US 2017/0337616 A1
(43) Pub. Date: Nov. 23, 2017

(54) 1 Click, Many Orders

(71) Applicant: Bal Maraj, Fullerton, CA (US)

(72) Inventor: Bal Maraj, Fullerton, CA (US)

(21) Appl. No.: 15/159,719

(22) Filed: May 19, 2016

(51) Int. Cl. G06Q 30/06; G06F 3/0482; G06Q 10/10; G06F 3/0481

(52) U.S. Cl. CPC G06Q 30/0633; G06Q 30/0641; G06F 3/04817; G06F 3/0482; G06Q 10/107

(57) ABSTRACT

This “1 click, many orders” method provides an easy to use cloud based ordering system via the internet. Any authorized user or users of the client system can place one or multiple orders simultaneously on the server system by the click of one button. Once the orders have been submitted, the server system process will generate the appropriate orders notification immediately. These notifications will consists of a summary of the order or orders along with the details associated with each order. All orders generated via the one click button will be combined and placed into a single summary email and sent to the appropriate authorized users based on the business rules setup by the client.

### BACKGROUND

Normally web or cloud based orders via the Internet are placed by the end users one order at a time and they receive email confirmations of their orders one email per order. This is a time consuming effort for both the end user and the host server system which is inconvenient and costly. With “1 Click, Many Orders” a user can place one or as many orders as they desire by the click of one button and receive only one summary email confirmation detailing all their orders transactions. This cloud base order system/process empowers the end user to place their orders 24×7 globally via a tablet, laptop or a smartphone. This process allows for the reduction in the number of orders placed and the number of emails associated with order creation which will result in time and cost savings.

### 1 CLICK, MANY ORDERS DETAILS

The embodiment of the solution is to enable users to generate and submit multiple orders with a single button ‘click’. The system is highly configurable by taking into consideration and applying an individual company's set of business rules and procedures. Depending on the configuration end-users will have the ability to create, modify and submit multiple orders simultaneously via one click. The solution will be cloud-based and have a connection to a company's server system.

Numerous benefits may be recognized by utilizing this functionality. Organizations will be able to clearly communicate and enforce cutoff days and times. By providing their customers with the ability to create and submit multiple orders simultaneously the customers can realize an increase in efficiency and productivity. This is accomplished by reducing the number of steps required to generate multiple or individual orders by enabling them to create, review and submit those orders simultaneously via one button click. Depending on the configuration, users creating the orders and users that have subscribed to receive email notifications of orders that have been created and submitted will now receive a fewer number of emails to review since the system will automatically combine the orders that have been created and submitted by the user at the same time together into a single email summary.

Users will access the cloud-based solution and select the location to which they will generate, review or modify orders for. Once within the order entry screen, they may select to review and work with the current week or future weeks. The order entry screen will allow them access to multiple weeks of previous sales history at an individual item level. This will enable them to make better informed decisions as to the quantities required to create a proper and efficient order. Depending on cutoff days and times, the users will be able to create and modify orders accordingly. They may do so individually or by entering the order quantities of all items within a predetermined period. They may then save, edit or review the orders prior to final submission. Once they are satisfied with the orders they may have them continue on to processing with a single ‘click’ of the “Submit” button.

End-users will have the ability to review orders that have been created and submitted. They may also be able to modify and re-submit orders that are still outside of predetermined cutoff days and times. The system will take into account the corresponding limitations and control what capabilities the user may access. Should the user make any modifications to any existing orders, they can be re-submitted for processing.

Once orders have been submitted, regardless of whether they are new or modifications of existing ones, notifications will be generated. If the user submitted multiple orders simultaneously they would be combined into a single email listing the attributes of the individual orders. The user that created and/or modified the orders along with ones that have subscribed to order submission emails of a given customer will automatically receive the corresponding order submission emails.

### BRIEF DESCRIPTIONS OF DIAGRAMS

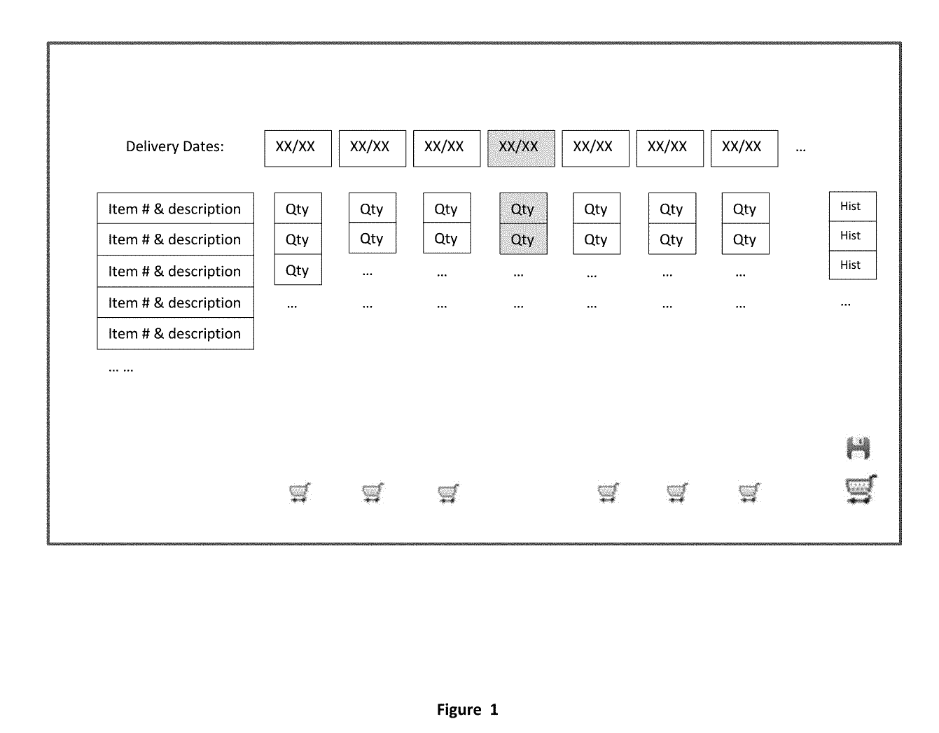

FIG. 1. A section of the order screen, showing multiple delivery dates, some of which are unavailable dates and shown as disabled. History button is located next to each item. Buttons at the bottom of each day allows the user to submit an order for a single day. A larger button to the right allows the user to submit orders for all of the days on the screen at the same time with a single click. A save button allows the user to save the orders without submitting to come back at a later time.

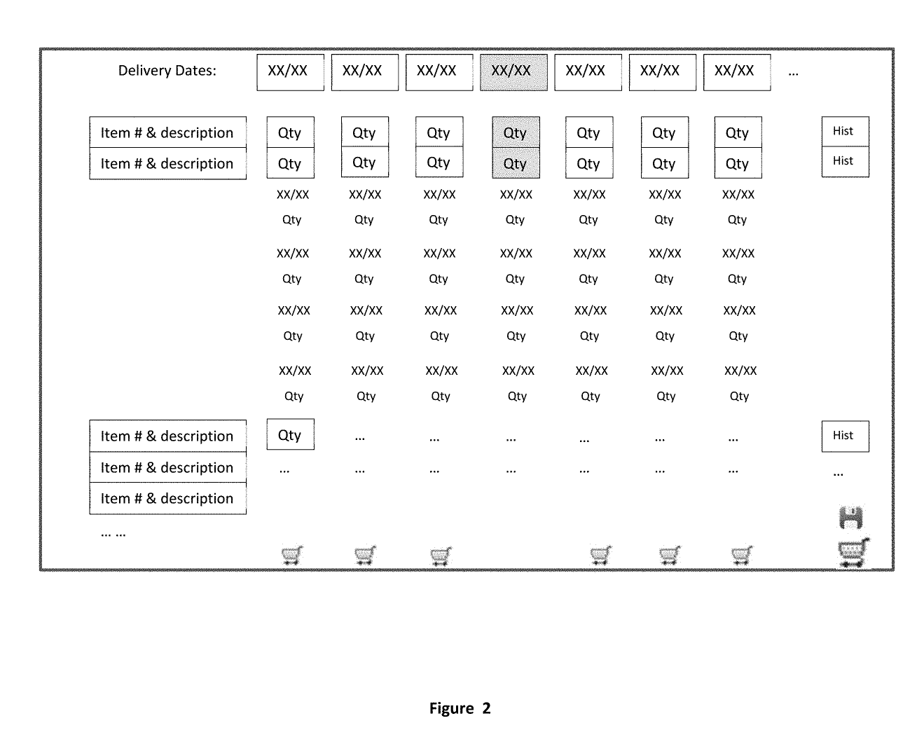

FIG. 2. A section of the order screen, showing multiple delivery dates, some of which are unavailable dates and shown as disabled. An item's history view has been opened on the screen to show prior order dates and quantities. Multiple items can have the history view open at the same time.

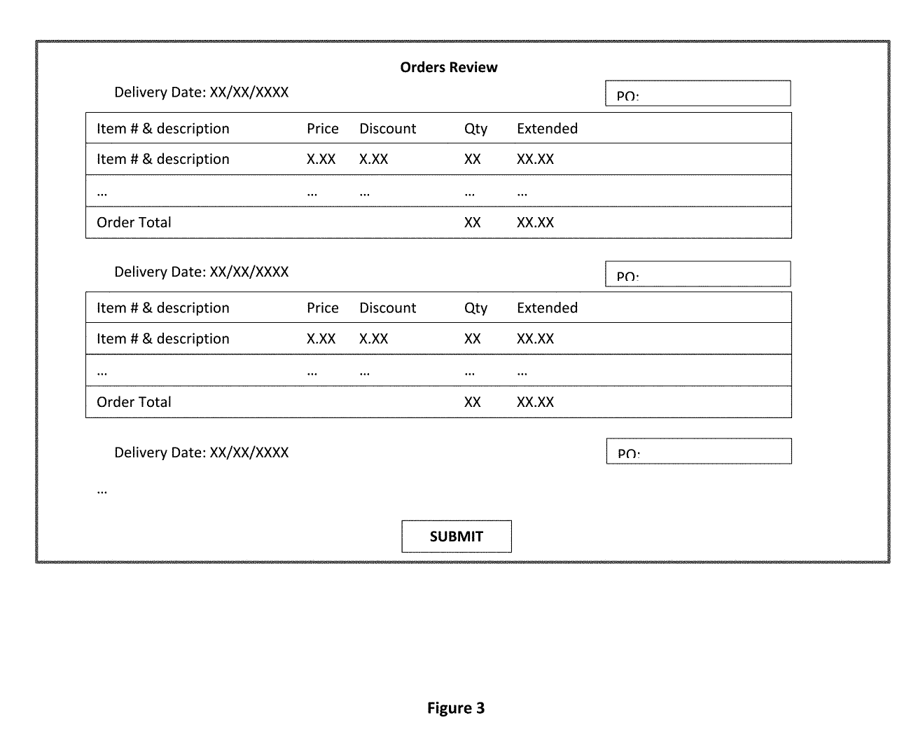

FIG. 3. A section of the review/submit screen, listing multiple delivery dates and their order quantities. Optional PO numbers can be entered for each order. A single Submit button on the screen allows the user to submit all orders shown on the screen at the same time with one single click.

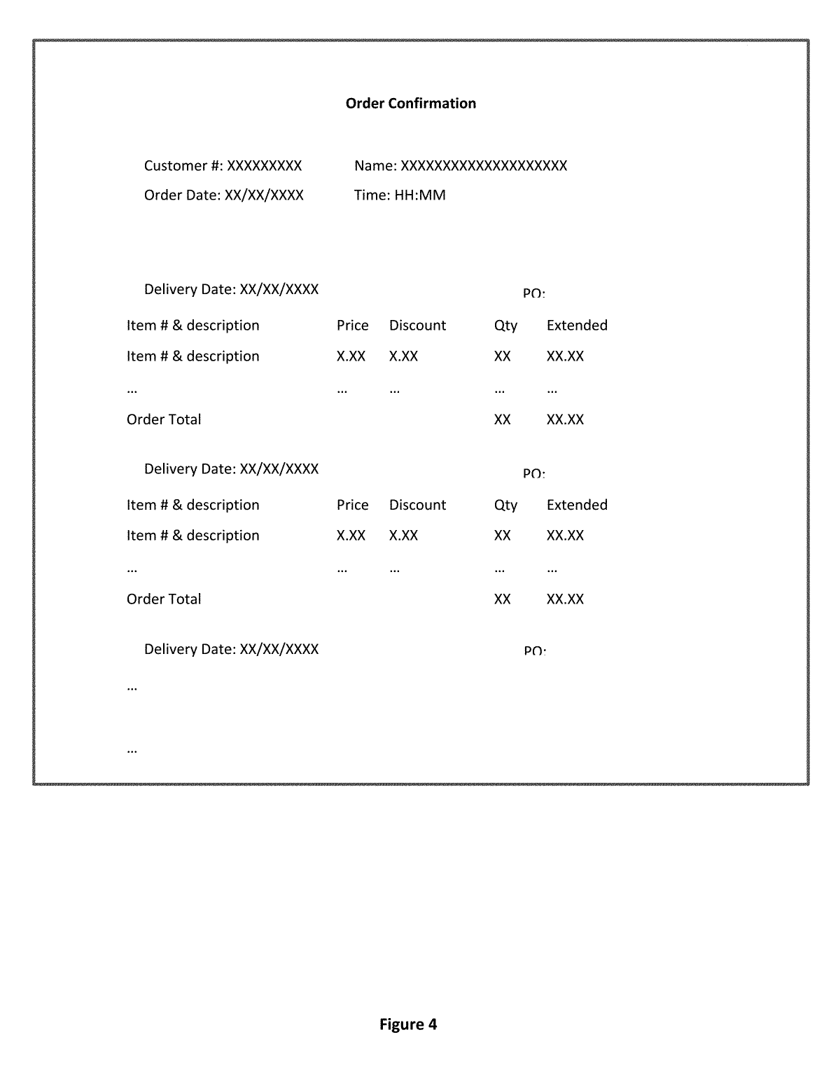

FIG. 4. A section of the order confirmation e-mail, listing multiple delivery dates and their order quantities, and other applicable customer and order information.

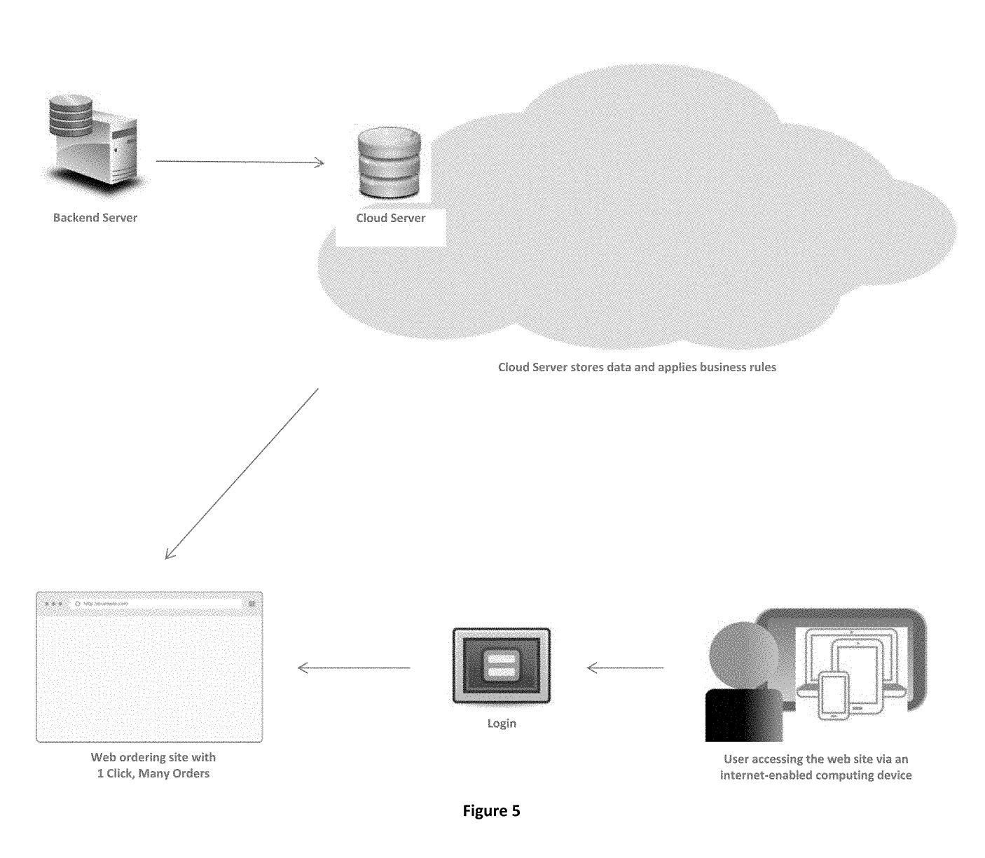

FIG. 5. A computer-implemented method that allows authenticated and authorized users to create/view/modify orders via the 1 Click, Many Orders method, from anywhere in the world using an internet-enabled computing device. The web ordering solution is hosted in the cloud with a connection to the client's backend system.

### 1 CLICK, MANY ORDERS SUMMARY

“1 click, many orders” is a cloud-based solution that enables companies to present an online ordering system to their customers. Organizations will be able to configure the system based on their unique set of business rules. Multiple benefits and efficiencies may be recognized by parties throughout the ordering and distribution process. The solution can be made available 24 hours a day, 7 days a week, 365 days a year. It can be accessed by virtually any internet connected device encompassing various web browsers.

One of the key aspects of the solution is the ability for end-users to submit multiple orders with a single button ‘click’. Authorized users will log in to the portal and select a customer to work with. Once they have done so they will be presented with a screen allowing them to generate multiple orders for their current week. This can depend on the configuration of the system and corresponding cutoff days and times. Depending on their desired workflow or their current needs, they may elect to create a single order or multiple orders. In an effort to provide them with information that would allow them to make better informed decisions, they can have access to multiple weeks' worth of sales history at the line item level. Once they have entered all applicable information they will proceed to review the order or orders and click the “Submit” button. This will then submit all orders that have just been created for processing.

Users will have access to review orders that have been previously submitted. If there are orders that need to be modified, the user may do so as long as they are still outside of the corresponding cutoff day and time windows. Once the modifications have been made, they may then re-submit the orders for processing. These too can be done individually or by modifying and submitting multiple orders simultaneously.

Once the orders have been submitted the appropriate notifications will be generated. These notifications will consist of a summary of the order or orders along with the details associated with each order. All orders created by the user simultaneously will be combined and placed into a single email. This allows for a reduction in the number of emails associated with orders created. The user that created the orders along with any other users subscribed to receive notifications of order submissions for a given location will automatically receive the emails.

1. A computer-implemented method for generating multiple orders with a single button ‘click’. The embodiment of the solution will allow end-users to submit multiple orders for processing with a single ‘click’ of a button. Taking into consideration a company's set of business rules, the cloud-based solution via the Internet will enable users to create multiple orders and then submit them all at once. Depending on criteria associated with configurable cutoff days and times, users may be able to access a varying number of days and weeks. Once the user has created the orders they can review all of them within a single summary screen and then submit them all for processing with a single click of the “Submit” button. The cloud-based solution via the Internet will have a connection to a company's server system.

2. A computer-implemented method for editing and saving multiple orders within a single screen. The embodiment of the procedure will enable users to review multiple orders, make modifications and save them with a single ‘click’ of a button as it relates to claim number 1. Taking into consideration a company's set of business rules, appropriate users will be able to access, review and modify orders. Once the orders have been modified accordingly, the users will be able to save multiple orders with a single click of the ‘Save’ button. The solution will be cloud-based via the Internet and have a connection to a company's server system.

3. A computer-implemented method to review and modify orders prior to submitting them for processing. The embodiment of the function will enable end-users to review and modify multiple orders simultaneously prior to submitting them for processing as it relates to claim number 1. The users will access the solution to select and review or modify a weeks' worth of orders at a time. Should any of the orders necessitate modification, the end-users will be able to update them accordingly then submit them for processing all at once. The solution will be cloud-based via the Internet and have a connection to a company's server system.

4. A computer-implemented method of creating, reviewing and submitting orders individually or as a group within a single screen. The embodiment of the function allows end-users to work with and submit orders either individually or as a group as it relates to claim number 1. Taking into consideration a company's set of business rules, the system will allow for the creation, modification and submission of a single order or multiple orders within a single screen. Once the orders have been entered the user may select to either proceed with an individual order or with multiple orders. They will do so by clicking on the corresponding icon. Once they have chosen to proceed, they will be able to view a summary of the order(s) and submit it/them for processing. The solution will be cloud-based via the Internet and have a connection to a company's server system.

5. A computer-implemented method of reviewing multiple weeks' worth of sales history while creating and/or modifying orders. The embodiment of the function allows authorized users access to multiple weeks' worth of sales history during the order creation, modification and review processes as it relates to claim number 1. Taking into consideration a company's set of business rules, the system may be configured to show by item, sales history information from multiple previous weeks. Users can then utilize this information during the order creation process. That can enable users to be better informed as to the appropriate order quantities of the various products. They can then create and submit multiple orders simultaneously with one button click. The solution will be cloud-based via the Internet and have a connection to a company's server system.

6. A computer-implemented method of simultaneously modifying multiple orders that have already been submitted within a single screen. The embodiment of the solution enables authorized users to simultaneously modify multiple orders that already exist. Taking into consideration a company's set of business rules and processes, end-users may be able to modify orders that are still outside of the predetermined cutoff days and times. Once the users have selected the orders and made the appropriate modifications they can elect to review and submit them individually or as a group via one click. Once the order modifications have been submitted, corresponding notifications will be generated and emailed as defined. The solution will be cloud-based via the Internet and have a connection to a company's server system.

7. A computer-implemented method of generating notifications for multiple orders submitted and/or modified. The embodiment of the solution will automatically generate one email notification containing the details of multiple orders that have been submitted at the same time. The email notification containing the details of multiple orders will be sent to the authorized user that created the orders as well as any additional users that have subscribed to receive notifications when orders are submitted. This scenario shall encompass orders that are initially created and/or ones that have been modified and re-submitted. The solution will be cloud-based via the Internet and have a connection to a company's server system.

8. A computer-implemented method that automatically combines and sends a single email notification consisting of multiple orders. The embodiment of the procedure shall combine and encompass the attributes of multiple orders to generate and send a single email as it relates to claim number 7. End-users will be able to access the solution to create and/or modify multiple orders simultaneously. Once the orders contain the desired quantities or the necessary modifications, they will submit them for processing. Part of this process will take and combine the multiple orders into a single email reflecting the details of the individual orders. This will result in a reduction in the number of emails individuals may receive as they relate to orders being submitted. The solution will be cloud-based via the Internet and have a connection to a company's server system.

9. A computer-implemented method that allows authorized users to receive email notifications containing multiple order summaries. The embodiment of the procedure will enable authorized users subscribed to notifications based on orders being submitted to receive a single email containing multiple orders as it relates to claim number 7. Authorized users that have subscribed to receive order submission notifications will be able to recognize a reduction in the number of emails received due to the system method combining multiple orders that were submitted simultaneously into a single email detailing the attributes of the individual orders. The solution will be cloud-based via the internet and have a connection to a company's server ERP system.
